(19) United States
(12) Patent Application Publication
(10) Pub. No.: US 2005/0086342 A1
(43) Pub. Date: Apr. 21, 2005

(54) Techniques for client-transparent TCP migration

(76) Inventors: Andrew Burt, Golden, CO (US); Ramakrishna Thurimella, Centennial, CO (US); Sada Narayanappa, Highlands Ranch, CO (US)

Correspondence Address: SHERIDAN ROSS PC, 1560 BROADWAY, SUITE 1200, DENVER, CO, 80202, US

(21) Appl. No.: 10/946,277

(22) Filed: Sep. 20, 2004

Related U.S. Application Data
(60) Provisional application No. 60/504,385, filed on Sep. 19, 2003.
(60) Provisional application No. 60/527,993, filed on Dec. 8, 2003.

(51) Int. Cl. G06F 15/173

(52) U.S. Cl. 709/224; 709/223; 709/242

(57) ABSTRACT

Embodiments of the present invention provide increase resiliency to server failures by migrating TCP-based connections to backup servers, thus mitigating damage from servers disabled by attacks or accidental failures. The failover mechanism described is completely transparent to the client. Using these techniques, simple, practical systems can be built that can be retrofitted into the existing infrastructure, i.e. without requiring changes either to the TCP/IP protocol, or to the client system.

### CROSS-REFERENCE TO RELATED APPLICATIONS

This application claims the benefit of U.S. Provisional Application Ser. No. 60/504,385, filed Sep. 19, 2003, and the benefit of U.S. Provisional Application Ser. No. 60/527,993, filed Dec. 8, 2003, the entire disclosures of which are hereby incorporated herein by reference.

### FIELD OF THE INVENTION

Embodiments of the present invention are directed to the migration of TCP connections in order to provide enhanced reliability, without requiring alterations to existing clients, including their TCP implementations. For example, according to one embodiment of the invention, techniques for enhancing the reliability of TCP connections that work without changes to existing servers are provided.

### BACKGROUND OF THE INVENTION

While great strides have been made in providing redundancy of network components such as switches and routers, and in proprietary applications such as used in database servers, a missing component in end-to-end fault tolerance has been the ability to migrate open transmission control protocol (TCP) connections across server failures. This is especially important for long-running connections, such as used in streaming video, Internet telephony, database transactions, etc.

The TCP protocol was designed with the underlying assumption that a connection would only be between two specific hosts, and that if one host were to become unavailable the connection should be severed. However, in its popularity, doubtless due to its other aspects of reliability, TCP has been adopted widely as the pre-eminent protocol for “reliable” connections. Recent research has suggested enhancements to TCP or other modifications to clients to make them resistant to server crashes, and these are desirable in the long run. However, such enhancements face adoption challenges in the near future because they rely on changes to software on all existing clients, of which there are hundreds of millions. One way to achieve fault tolerance is to build recovery machinery into the server and develop clients to take advantage of this feature. The feature may be user controlled, such as the “REST” restart command in FTP, or it may be hidden from user control. An example of such a methodology is Netscape's SmartDownload that is currently gaining some popularity. This approach requires modifying the clients and servers, and recoding of applications.

The recent explosive growth of the Internet has spurred developments in switching technology that include application-level or Layer 7 switching. These switches work at the granularity of a complete connection; for short web connections this solution is satisfactory. Extending the functionality of switches, e.g. load balancing or connection recovery, beyond what they are normally capable of doing complicates their design and bogs down their performance. Papathanasiou and Hensbergen propose KNITS, a mechanism for connection handoff initiated by one of the back-end nodes. Their method allows some of the complexity to be shifted from the switches to one of the backend nodes. Specifically, the role of the dispatcher is moved out of the switch to one of the back end nodes. This allows for scaleable switches. KNITS currently has no capabilities to handle server failures, and is further limited in failover use by virtue of requiring involvement from the back end servers and by only operating with static content.

For the fault-tolerant delivery of streaming media and Internet telephony, Snoeren, Andersen, and Balakrishnan propose a set of techniques for fine-grained fail-over of long-running connections across a distributed collection of replica servers. Their method depends on TCP migrate options and requires changes to both the client as well as the server. Sultan, Srinivasan, and Iftode propose MTCP, a new transport layer protocol for highly-available network services achieved using transparent migration of the server endpoint of a live connection between cooperating servers. Their migration mechanism is initiated by the client and does not work with legacy user agent software based on TCP. A similar approach is embodied in STCP, the Stream Control Transport Protocol, which allows migration of connections. However, being a separate protocol, it would require installation on a client host and is thus impractical for many legacy clients.

MSOCKS is a proxy-based system for mobile clients proposed by Maltz and Bhagawat that is capable of redirecting the end points of an existing transport session to arbitrary addresses. An architecture known as Transport Layer Mobility is introduced. Using this method, one can achieve connection redirection, but the application needs to be built on this new transport layer, thus requiring non-trivial modifications to legacy clients. Similar work was also proposed in with similar constraints. Optimizing the performance of the proxy that forwards TCP packets is discussed in, which proposes TCP connection splicing as a potential solution for mobile hosts (i.e. reconnecting using new IP numbers), but this solution assumes no loss of state, thus the difficulty of migration across server failures is not addressed.

MIGSOCK is a mechanism that supports socket migration as part of process migration at the operating system level. A Linux kernel module that reimplements TCP to make migration possible is presented in. These authors assert that MIGSOCK can also be used for the purposes of a connection hand off in the context of load balancing http requests. MigS is a similar connection-migration system that provides dynamic connection management for applications. However, these systems require all participating hosts, including clients, to support migration capability (hence modification of client protocol stacks).

Much of the previous work for improving the reliability of TCP connections proposes modifications to TCP thus making client transparency difficult, if not impossible. One way to make solutions that modify TCP work with legacy clients is by interposing a proxy: it uses the new protocol by default, but switches to TCP if that is the only protocol the client understands. This approach in general has drawbacks. For example, instead of removing the original single-point of failure, it introduces another. These methods also create an additional point of indirection, potentially impacting performance of normal communication and potentially introducing an additional security vulnerability.

### SUMMARY OF THE INVENTION

Embodiments of the present invention provide tools that enhance reliability, which can be simply attached to the existing infrastructure without making any modifications to the server or the client. For example, embodiments of the invention provide techniques to migrate open TCP connections in a client-transparent way. Using these techniques, it is possible to make a range of TCP-based network services such as HTTP, SMTP, FTP, and Telnet fault tolerant. Embodiments of the present invention may be operable to recover TCP sessions from all combinations of Linux/Windows/UNIX clients/servers.

One embodiment of the invention disclosed herein achieves server failover of TCP connections without any modifications to client systems or existing protocols (and generally without modifications to servers). In an embodiment nicknamed Jeebs (Jeebs, from the film Men in Black, being the alien masquerading as a human who, when his head is blown off, grows a new head), a “black box” is placed on the server's network for the purposes of monitoring all TCP connections for the specified server hosts and services, detecting loss of service, and recovering the TCP connections before the client's TCP stacks are aware of any difficulty. Embodiments of the present invention recover from all combinations of Linux/Windows/UNIX clients/servers, and demonstrate seamless operation across server failures of many services, including HTTP, Telnet, SMTP, and FTP.

In order to ensure that embodiments of the present invention are capable of operating with the hundreds of millions of existing Internet, intranet, and other TCP/IP-capable clients, it is desirable that embodiments of the present invention be completely transparent to clients. In particular, embodiments of the present invention require no changes of any kind to any client system: No changes to clients implies no changes to the TCP protocol, as has often been required by other solutions. This has the general benefit of requiring no kernel changes to server hosts, according to one embodiment of the invention, as well. Changes to server daemons can in most cases be avoided also, with some exceptions as noted herein.

A system in accordance with one embodiment of the present invention that is capable of recovering sessions that are about to time out can be considered as comprising two components: (1) A monitor, to record pertinent information about existing connections and detect their imminent demise; and (2) a recovery system that can perform emergency reconnection to a new or backup server that will take over the connection.

The monitor operates by logging traffic from the server host it is watching. In accordance with an embodiment of the present invention, the granularity of recovery is at the IP number level. The monitor can be further selected to only watch certain ports, but since the entire IP number is migrated to a new server, all ports on that IP number should be monitored in practice. However, since virtual IP numbers are used in practice, specific services can be isolated so that they are the only services using a given IP number. Thus individual services can be migrated if they are the only services using that virtual IP number. Logging includes the TCP state information, unacknowledged data, and any prior data that may be required for recovery purposes (such as initial requests). Further, the monitor observes the health of each connection to detect imminent failure. Methods employed may include pinging, detecting retransmit requests, and attempting connections to the service.

When an IP number is deemed in need of migration, all connections to that server are restored via the recovery system. The recovery system takes over the IP number of the designated server and initiates recovery of each connection. Connections are restored using per-service recovery procedures. According to an embodiment of the present invention, a standalone recovery system is provided. In a standalone recovery system, a software application is provided that handles connections in progress, with new connection requests being serviced by a copy of the original, unmodified daemon for that service. In accordance with another embodiment of the present invention, an integrated system is provided. In an integrated system, a service daemon on the recovery system is modified to understand how to adopt stranded connections, in addition to handling new requests. In accordance with still another embodiment of the present invention, a proxy recovery system is provided. In a proxy system, a small, programmable daemon interposes itself between the client and a backup copy of the unmodified service daemon, such that it can replay the necessary parts of the original connection to bring the new server up to the point the original server failed, then acts in a pass-through mode while the new server finishes the connection.

Migration may be performed in connection with a wide variety of services, including HTTP, FTP, TELNET, SMTP, rlogin, rcp, and Windows services. Such migration can be accomplished with easily produced recovery components; intricacies of each are discussed elsewhere herein. With (generally minor) changes, these components could be adapted to services such as HTTPS, SSH, and Kerberos.

In accordance with an embodiment of the present invention, existing connections between servers and clients are migrated to a backup server in the event that the primary server becomes unavailable. In particular, one embodiment of the present invention overcomes inadequacies in TCP/IP protocols, which do not allow an existing connection to be moved to a backup server. Furthermore, embodiments of the present invention allow backup capabilities to be provided, without requiring changes to existing clients. In addition, embodiments of the present invention can provide backup capabilities without requiring changes to existing servers.

In accordance with an embodiment of the present invention, a standalone system is provided. The standalone system connects to the TCP/IP network, and acts as a “hot backup” to existing servers. In the event of a server failure, or if a server otherwise becomes unavailable, the backup system takes over existing “open” TCP/IP connections between clients and their (now unavailable) servers. In accordance with another embodiment of the present invention, software for monitoring and recovering (or continuing) connections is installed on existing backup hardware. Accordingly, existing backup systems can be modified by installing software to allow for the monitoring and recovery of TCP/IP connections in accordance with the present invention.

In accordance with still other embodiments of the present invention, hardware and software can be modified to incorporate or implement embodiments of the present invention. Accordingly, hardware and/or software initially installed or intended for functions other than those provided by the present invention may be modified and thereby enhanced such that they are capable of monitoring and recovering TCP/IP connections.

In accordance with various embodiments of the present invention, existing TCP/IP connections between one or more clients and servers are monitored. In general, the monitor functions to log information regarding each monitored IP number. In addition, the monitor observes the health of each connection for imminent failure. When a monitored IP number is determined to be about to lose its open connections, a recovery host takes over those connections. Accordingly, at least from the perspective of the clients, the connections are maintained.

In addition to the aforementioned, TCP is neither secure nor can withstand server failures due to malevolent intrusion, system crashes, or network card failures. Nonetheless, today's information assurance requirements demand building software, networks and servers that are resistant to attacks and failures. While individual connections can be made secure from eavesdropping or alteration by such protocols as the Secure Shell protocol (SSH), the server that provides these services continues to be a single point of failure. This is an artifact of TCP's original design, which assumed connections should be aborted if either endpoint is lost. That TCP also lacks any means of migrating connections implies that there is no inherent way to relocate connections to a backup server. Thus any secure software built on top of TCP inherits the vulnerability of the single server as a point of failure. Combining TCP with a mix of public key and symmetric key encryption such as SSH or SSL addresses the protocol's general security deficiency. Some embodiments of the present invention increase the resiliency of secure connections to address server failures. More specifically, these embodiments provide ways to migrate active SSH connections to backup servers that do not require any alterations to client-side software, including their client application software, operating systems, or network stacks, thus making this solution immediately deployable. These techniques are general and can be employed for other forms of secure connections, such as SSL.

In accordance with the further embodiments of the present invention, secure connections may be provided with monitoring and recovery services. One embodiment for secure connections (“SecureJeebs”), includes making simple, modular and secure extensions to the SSH software and placing a “black box” on the server's subnet to monitor all TCP connections for the specified server hosts and services, detect loss of service, and recover the TCP connections before the clients' TCP stacks are aware of any difficulty.

While great strides have been made in providing redundancy of network components such as load balancing switches and routers, and in proprietary applications such as used in database servers, a missing component in end-to-end fault tolerance has been the inability to migrate open TCP connections across server failures. Embodiments of the present invention eliminate servers as a single point of failures. Embodiments of the present invention are further distinguished from load balancing and other techniques in that such embodiments transparently and securely migrate secure connections that are in progress. This feature permits embodiments of the present invention to be used not only to enhance reliability of unreliable servers, but also to take production servers offline for scheduled maintenance without disrupting the existing connections.

### BRIEF DESCRIPTION OF THE DRAWINGS

FIG. 1 depicts components of a recovery system in accordance with embodiments of the present invention, before failure of a connection;

FIG. 2 depicts components of a proxy type recovery system in accordance with embodiments of the present invention, after recovery of a failed connection;

FIG. 3 depicts components of an integrated type recovery system in accordance with embodiments of the present invention, before recovery of a failed connection;

FIG. 4 depicts components of a standalone type recovery system in accordance with embodiments of the present invention, after recovery of a failed connection;

FIG. 5 depicts components of an integrated type recovery system in accordance with embodiments of the present invention, after recovery of a failed connection;

FIG. 6A depicts components of a recovery system for use with a secure connection in accordance with the embodiments of the present invention, before failure of a connection;

FIG. 6B depicts components of a recovery system for use with a secure connection in accordance with embodiments of the present invention, after recovery of a failed connection;

FIG. 7 depicts an SSH protocol packet exchange;

FIG. 8 depicts a Diffie-Hellman group and key exchange;

FIG. 9 depicts SSH packet format;

FIG. 10A is a graph illustrating recovery ratio in accordance with embodiments of the present invention;

FIG. 10B is a graph depicting the average recovery time versus number of open sessions in accordance with a embodiments of the present invention;

FIG. 11 illustrates aspects of the operation of a monitor in accordance with embodiments of the present invention;

FIG. 12 is a flowchart depicting aspects of the operation of a standalone recovery server in accordance with embodiments of the present invention;

FIG. 13 is a flowchart depicting aspects of the operation of an integrated recovery system in accordance with embodiments of the present invention; and

FIG. 14 is a flowchart depicting aspects of the operation of a proxy recovery server in accordance with embodiments of the present invention.

### DETAILED DESCRIPTION

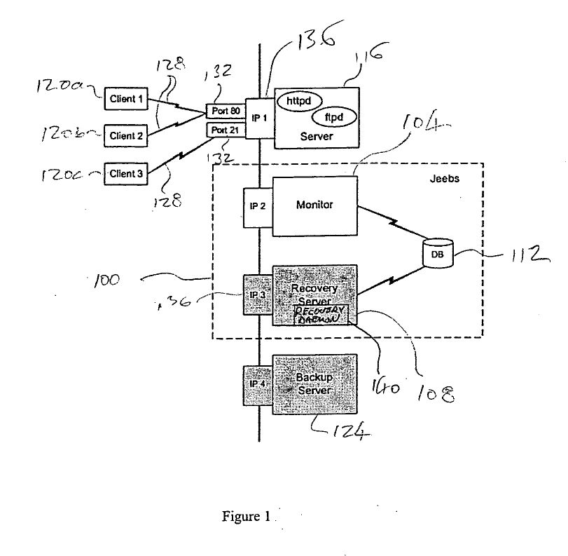

With reference now to FIG. 1, components of a recovery system 100 in accordance with embodiments of the present invention are illustrated. As shown in FIG. 1, the recovery system 100 generally comprises a monitor 104 and a recovery server 108. In addition, the recovery system 100 may include or be associated with a database 112. The recovery system 100 is generally deployed in connection with a server 116 that serves one or more clients 120a-c. In addition, a backup server 124 may be provided.

During normal operation, the clients 120 may establish connections 128 with the server 116. In particular, the clients 120 may connect to ports 132. The ports 132 may be provided as part of or in association with an IP number 136 for the server 116. The IP number may be an actual IP number visible to the clients 120, or it may be a virtual IP number translated by front end routers and switches to an appropriate host.

In accordance with embodiments of the present invention, recovering TCP sessions that are about to abort due to loss of the server requires two components: (1) the monitor 104, to record pertinent information about existing connections and detect their imminent demise; and (2) the recovery system 108 that can perform emergency reconnection to a new server that will take over the connection.

In embodiments of the present invention, the monitor 104 operates by logging traffic from the server host it is watching. In particular, according to embodiments of the present invention, the monitor 104 component of the system observes or monitors existing connections to detect their imminent demise. Accordingly, the monitor 104 operates to determine when a given service on or through the server 116 has become unavailable, and to log pertinent connection data so a connection can be recovered. The granularity of recovery is at the IP number level. The monitor 104 can be further selected to only watch certain ports 132, but since the entire IP number 136 is migrated to a new server, all ports 132 on that IP number 136 should be monitored in practice. Since virtual IP numbers are used in practice, specific services can be isolated so that they are the only services using a given IP number. Thus individual services can be migrated if they are the only services using that virtual IP number. Logging includes the TCP state information, unacknowledged data, and any prior data that may be required for recovery purposes (such as initial requests). Further, the monitor 104 observes the health of each connection 128 to detect imminent failure. Health monitoring and server crash detection use standard techniques as described elsewhere in the literature. The recovery system 100 may be installed on the server's 116 subnet to monitor and recover connections to recover what appear to be local server crashes. Packets are logged at the TCP level by a sniffer. Recovery of TCP state is handled via a passive recovery daemon 140 on the recovery server 108, and application state is migrated using simple, per-protocol recovery modules described here. Connections 128 are recovered to a backup server 124, which may co-exist with the recovery server or be a separate system on the subnet, as described in greater detail elsewhere herein.

When an IP number is deemed in need of migration, all connections 128 to that server 116 are restored by the recovery system 100. The recovery system 100 takes over the IP number of the designated server 116 and initiates recovery of each connection 128. Connection state is restored using simple per-service recovery procedures. There are three styles of recovery: Standalone, where a new piece of software is written specifically to handle connections in progress (with new connection requests being serviced by a copy of the original daemon for that service); Integrated, where the existing service daemon on the recovery system 100 is modified to understand how to adopt stranded connections (in addition to handling new requests); and Proxy, where a small, programmable daemon interposes itself between the client 120 and a backup copy of the original service daemon 124, such that it can replay the necessary parts of the original connection to bring the new server up to the point the original server failed, then acts in a pass-through mode while the new server finishes the connection. Session keys and other sensitive data needed to ensure the integrity of secure connections are likewise migrated in a secure manner as described in detail below.

Health status of a connection 128 has been covered elsewhere in the literature. E. Amir, S. McCanne, and R. Katz. An active Service Framework and its Application to Real-time Multimedia Transcoding. In Proc., ACM SIGCOMM '98, September 1998; A. Fox, S. Gribble, Y Chawathe, and E. Brewer. Cluster-based Scalable Network Services. In Proc. ACMSOSP '97, October 1997, and V. S. Pai, M. Aron, G. Banga, M. Svendsen, P. Druschel, W. Zwaenepoel, and E. Nahum. Locality-aware Request Distribution in Cluster-based Network Servers. In Proc. ASPLOS '98, October 1998. The entire disclosures of these references are hereby incorporated herein by reference. Embodiments of the present invention use these same methods for determining potential connections 128 to migrate and can easily be modified to include others. For example, periodically pinging the virtual IP number can be done to determine network reachability. Embodiments of the present invention can also monitor for TCP retransmit requests and use the existence of such as a tip to check the health of a server or service. Furthermore, embodiments of the present invention can attempt to connect to a stalling service to see if it is able to, and take a connection failure as a further sign of potential trouble. Still another method may comprise a health daemon running on the server that could be contacted to verify that a given service is still alert.

In accordance with embodiments of the present invention, logging is performed by placing the NIC in promiscuous mode and entering data into a database 112. Packets may be logged as-is, as well as aggregated into contiguous blocks of messages delineated by reversal of traffic flow. Thus for request-reply based protocols, the recovery daemon can ask for “message 1” or “message 1 from client to server”, etc. and be given the entirety of the message whether it spans packets or not. Packets are available for recovery to examine TCP options, although obviously necessary data such as initial and most recently acknowledged sequence numbers may be stored in separate fields for easy inspection.

In general, the monitor 104 requires that the monitored server's 116 packets be sniffable. Therefore in accordance with embodiments of the present invention, the monitor 104 and recovery servers 108 are on the same network segment as the server 116 to be monitored. In accordance with other embodiments of the present invention, the common switch has a port mirroring capability. In accordance with still other embodiments of the present invention, the monitor 104 is built into switches. Also, although illustrated as separate servers, it should be appreciated that the monitor 104 and recovery server 108 can be integral to one another. Since the present invention addresses server failure, it is reasonable and practical to place the Jeebs “black box” recovery system 100 onto the same network segment. As others have pointed out (See, e.g., C. Snoeren, D. G. Andersen, and H. Balakrishnan. Fine-Grained Failover Using Connection Migration. In Proc. 3rd USENIX Symp. on Internet Technologies and Systems (USITS), March 2001), placing a recovery system 100 on a protected network segment does not solve problems with connectivity outside the server 116, such as failure of a switch (though this can be handled with parallel switches) or single link connectivity to the site (via redundant links), nor of course catastrophic failure of the site (fire, earthquake, etc.). However, by placing the recovery system 100 on the network segment, recovery data can be acquired rapidly, and therefore the system 100 is able to delay the decision to call a connection 128 about to be lost until the last moment, giving connections ample time to resume on their own and reducing false positives. Accordingly, the disclosed invention provides a practical solution in that it can be deployed without requiring alterations to servers 116 or TCP itself.

In accordance with an embodiment of the present invention, all packets are logged, including acknowledged packets, in case a recovery daemon desires to inspect earlier communications. Logged packets may be stored in the database 112. For example, an FTP recovery daemon (FTPD) might be interested in locating commands that change the server state (such as “CHDIR” requests). In accordance with a further embodiment of the present invention, only unacknowledged data is retained for large classes of connection types, such as from FTP data connections, static HTTP requests, streaming video, etc. Determination of what to log and what to remove once acknowledged is done in connection with the style of recovery daemon chosen, as discussed in the next section.

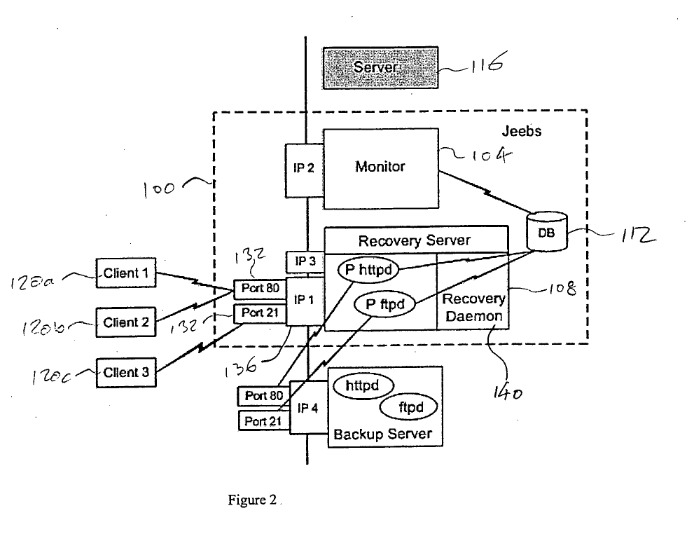

In accordance with embodiments of the present invention, service recovery is at the level of a virtual IP number: When a given IP number is determined to be about to lose its open connections (FIG. 2), that IP number is taken over by the recovery host or server 108 (one recovery style is illustrated in FIG. 2). The IP number may be an actual IP number visible to the clients, or it may be a virtual IP number translated by the site's front end routers and switches to an appropriate host.

In accordance with embodiments of the present invention, it is assumed that virtual IP numbers are used to group services that will be recovered together. Thus if HTTP is to be recovered along with HTTPS, these would be presumably be grouped together so that if, for example, HTTP+HTTPS reside on 10.0.0.1 FTP may reside on 10.0.0.2. All three may of course reside on the same physical host, and if that host crashes (vs. just the HTTP daemon (HTTPD) itself) then both 10.0.0.1 and 10.0.0.2 would be recovered. If only HTTP is detected as unresponsive, then only 10.0.0.1 would be recovered.

Actual recovery is effected by bringing up a new virtual interface on the recovery server 108 with the desired virtual IP number 136. The ARP cache of the requisite routers and switches are updated.

In accordance with another embodiment of the present invention, resurrection of the original server 116 need not be specifically addressed, on the presumption that adequate measures are taken to only perform recovery on connections that are truly mortally wounded. However, other precautions could be taken. If the switch can be configured to discard packets from the original MAC address and IP number pair, then nothing happens. Alternatively, the server 116 may be modified to detect that its IP number 136 has been relocated and silently shut down that interface. To prevent resumption after server crashes, the server 116 may be modified so that at reboot it allocates new virtual IP numbers 136 not in use by contacting a local IP manager, e.g. via DHCP.

In accordance with another embodiment of the present invention, the IP number itself need not be assumed, but the router providing the network address translation could be told map the new server's virtual IP number to the externally visible IP number in place of the downed server's 116 (and likewise not to route packets to the downed server's IP number until further notice).

The most likely scenario of inaccurate detection and inadequately preventing IP number reuse is if the server 116 was merely being slow. In the worst case, the connection may get aborted (original server sends duplicate (or pseudo-duplicate) data which may get dropped or interfere with the connection to the point where the client aborts, or the server aborts after hearing no ACK.). However, assuming the monitor 104 is reasonable at detecting downed servers 116, in the rare event this should happen, it would be no worse than the lost connection the recovery is attempting to prevent. Regardless of implementation, the goal is to route the client's 120 existing connection 128 so the recovery server 108 sees it as its own. With the migration of the client's 120 view of the IP number 136 complete, the process proceeds to migrate each open connection.

In accordance with an embodiment of the present invention, when the monitor 104 determines that a given IP number 136 requires recovery, it consults the database 112 of all open connections for that IP number. For each pending service (HTTP, FTP, TELNET, etc., i.e. on a per-port basis) it forks a service-specific recovery daemon 140 (on this or other recovery host 108, to balance loads as needed) to handle all in-process connections for the given (IP number, port number) pair. The service-specific recovery daemon 140 handles the set of open connections as best needed for that service: It may fork a connection recovery daemon for each pending connection 128, or handle the pending connections 128 in a multi-threaded manner, with the usual efficiency arguments applying. For simplicity of discussion, it may be assumed there is an entity called a connection recovery daemon 140 for each TCP connection to be recovered. However, a connection recovery daemon 140 is not required for each TCP connection to be recovered.

Actual migration for a given connection 128, as identified by client IP number, client port number, server IP number, and server port number, from the unavailable server 116 is handled within the connection recovery daemon 140 by: (1) retrieving the TCP connection state for the designated connection 128 from the monitor's database; (2) opening a new socket; (3) invoking a system call to place the TCP state information onto the new socket, including seeding buffers with any unacknowledged data; and (4) now that the TCP connection 128 is recovered at the transport layer, invoking the per-service recovery strategy, as discussed below.

Note that in order to invoke a system call to place the TCP state information onto the new socket, custom kernel modifications may be required. For example, modifications may be made to a RedHat Linux 7.2 kernel (2.4.18). Although the recovery server 108 may require this custom kernel logic, it is independent of the operating system of either the client 120 or the original server 116. Thus the “network appliance” concept is preserved: It is possible to plug in a set of recovery servers 108 onto a network without modifying the original server 116 or placing demands on the nature of the original server 116. The recovery server's 108 kernel bears the burden of ensuring the TCP packets it transmits will be identical to those that would have been sent by the original server 116. This is generally only complicated by certain TCP options, such as PAWS authentication. However, since the recovery server 108 is a black box plug-in, with any needed kernel changes being localized inside this black box, the practicality of the solution is maintained. In practice, recovery of TCP sessions between a wide variety of client and server operating system pairs can be demonstrated, including combinations of Windows 95/98/NT/2000/XP, RedHat Linux 6.2/7.1/7.2/7.3, and Sun Solaris 9. In addition, embodiments of the present invention can also provide recovery services in connection with other operating systems.

The per-service recovery daemon 140 inherits an open TCP connection to a client 120 as well as a connection ID for use with the monitor's 104 database 112 of logged connection information. In accordance with embodiments of the present invention, the recovery daemon 140 has access to all the data described previously, which is to say all pertinent data about the connection 128 to be recovered, up to and including every byte transmitted by both parties and the associated TCP packet headers. Clearly many applications do not require this level of detail, but it is easier to discard or not log unneeded data than it is to acquire it if unavailable. In accordance with other embodiments of the present invention, only data that is likely to be needed is acquired. How acquired data may be used in given circumstances is described below.

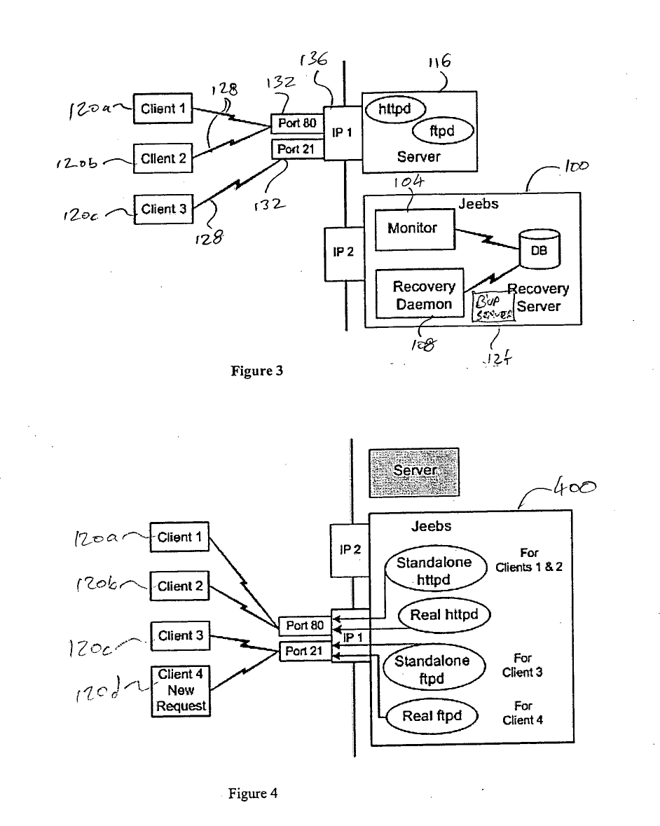

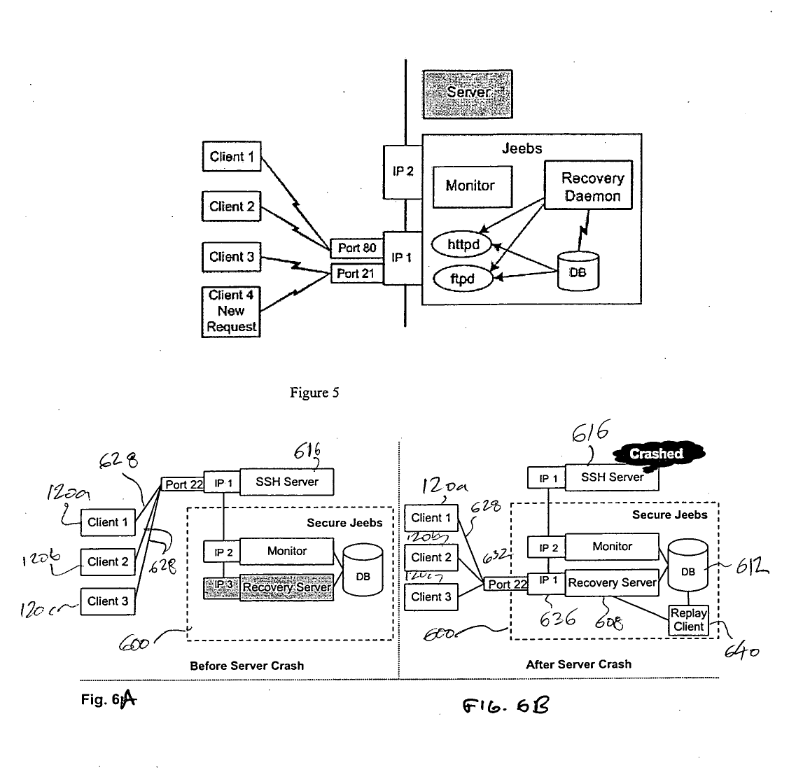

The per-service recovery daemon may take, for example, one of three general forms: (1) standalone; (2) integrated; (3) proxy. In brief, a standalone recovery style is a daemon that is designed to do nothing except handle recovered connections (e.g., is unable to handle new connection requests, which are handled by a copy of the original daemon for the service, with separate programs to handle resuming existing connections (i.e. connections that previously terminated in the original server 116)) (see, e.g. FIG. 4); an integrated recovery style would be one where the original service daemon has been modified to handle both new requests and re-establishing existing connections (thus requiring access to the source code of the original server daemon and possibly complex coding to integrate recovery logic) (see, e.g., FIGS. 3 and 5); and a proxy style is one where the recovery daemon first replays salient parts of the original connection and then operates in pass-through mode (see, e.g., FIG. 2).

A standalone recovery daemon is one that is dedicated to resumption of mid-stream connections. It is likely not able to handle new connections, just completing existing ones. Instead, new connections are handled by a copy of the original server daemon for the service that is separate from the recovery application for handling connections 128 in progress. FIG. 4 illustrates a standalone recovery system 400 in a post-recovery situation. The Standalone style is the most general form of the solution, but the one that typically requires the most effort to create. That is, it must be able to not only restore all needed states to the existing connection, but also duplicate all the functionality of the original server daemon to handle any new requests the client 120 may make on that open connection. In a standalone style system, new connections are handled by the original, unmodified FTPD, HTTPD, etc. while separate programs are provided for handling the resumption of existing connections. A simple example of a standalone recovery daemon might be to handle an existing FTP file transmission. i.e., not the control connection on a port where a “CHDIR”, “DIR” or “GET” command would be sent by the client, but on the subsequently opened connection for the actual transmission of file data. A standalone recovery daemon for this data transmission, of a single file, is a straightforward process: identify what portion of the file was already sent (or received) and resume sending bytes from the appropriate point.

An integrated recovery daemon may incorporate the recovery logic into the source code of an existing server, such as into Apache's httpd (FIG. 5). In particular, in an integrated system, the FTPD and HTTPD on the backup server 124 has been modified so that it can handle both resuming the existing connections and also accepting new connections. Accordingly, in an integrated system, the functions of the recovery system 100 may be integrated with those of the backup server 124. For example, the daemon may listen on an extra port for recovery requests. This approach has the advantage over a standalone server of being able to handle new connections as well as reuse existing logic for recovery purposes.

A proxy style recovery daemon in accordance with embodiments of the present invention, is akin to a standalone style in that it is not integrated into existing software, but is a separate daemon. However, it does not listen on any original service port, only on a port dedicated to recovery requests. When a recovery request arrives, the proxy begins by opening a new connection to an existing service daemon on a designated recovery host and replaying the initial part of the original conversation between the client and original server, a conversation it retrieves from the monitor's database. After replaying the connection up to the point it was (almost) disrupted, the proxy simply acts as a two-way pipe between the client and the new server. A hybrid of Proxy and Integrated could be contemplated for efficiency whereby the Proxy handles the replay then passes the open socket connection to the new server. In connection with such a hybrid embodiment, both the proxy and the new or backup server reside at the same IP number. In addition, for a hybrid system, the operation system should support the passing of open sockets, such as via I_SENDFD or SCM_RIGHTS, etc., or exec'ing with an open descriptor, inetd style.

The replay performed by a proxy recovery daemon may take one of three forms: (1) a byte-for-byte replay, with replies from the new server matched byte wise against responses from the old server (and the connection aborted if there is a mismatch); (2) a message-by-message replay, sending blocks of data in the same groups as originally exchanged between client and server, demarcated by reversals of direction of data flow and matched like the expect program; or (3) a custom replay module that understands the specific needs of the service (and may use the tools of the other two forms).

A byte-for-byte replay is useful in situations where the new server is designed to respond in the same manner as the original. For example, a “finger” server would take the same byte string as the input request and assuming the new finger daemon has been constructed to run the same software and have access to the same data, its response would align byte wise with that of the original server. Thus all that the proxy recovery daemon need do is go into pipe mode after replaying the initial number of bytes. The bytes from the new server are compared and ignored up to the point where they represent new, unsent data, and are then sent.

HTTP is another prime candidate for loose byte-for-byte replay—“loose” in the sense of disabling strict byte-wise checking of replies but only checking lengths. If the HTTP reply headers are arranged to be of the same length (by identical configuration of the original and new servers), then the date timestamps in the HTTP headers would be ignorable for their differences, but the byte counts would match up. Or, HTTP would be a good candidate for message-by-message replay.

A message-by-message replay would be useful in cases such as SMTP/sendmail, where the new server's replies may not match the original server's in exact byte count or exact content, but can be verified on a message-by-message basis. For example, recovery of a sendmail session in progress might begin with the new sendmail daemon sending

220 somewhere.com ESMTP Sendmail 8.9.3/8.9.3; Tue, 8 Jan. 2002 11:18:09-0700
whereas the original server might have originally replied as
   220 somewhere-slightly-different.com ESMTP Sendmail
8.8.3/8.8.3; Tue, 8 Jan. 2002 11:17:01-0700

That is, with possibly different length due to, for example, a hostname difference, certainly a different timestamp, and possibly other inconsequential differences like version number. (Assuming, of course, the version is suitably similar to handle the same protocol requests.) Because SMTP is in that category of numeric reply message style protocols, a simple expect type pattern matching system makes replay a simple matter of checking the reply codes and ignoring the text.

A custom replay module can also be easily incorporated and has access to all the utilities (such as message retrieval, matching, sending, etc.). FTP is an ideal candidate for a simple custom replay module because of the complexity of the FTP architecture. To recover an FTP session one would not need or want to replay all the client's commands to the FTP server. The custom replay module would honor state changing commands, such as CHDIR. However an old, completed “DIR” or “GET” would be unnecessary to replay. The last data transferring command, such as GET, PUT, or DIR, which opens a separate and additional TCP connection, also requires custom attention. The actual transmission of an in-progress GET command might be already handled by, say, a Standalone style recovery daemon. Thus the replay of the most recent/in-progress GET command is technically unneeded, since the file is already being recovered and transferred. However, the client's FTP is expecting something like a “226 Transfer complete.” message. Thus the custom replay module could (a) send a simple/dummy command, say “DIR xyzzy” that mimics the same reply messages (e.g. “200 PORT command successful.”, “150 Opening ASCII mode data connection for file list.”, “226 Transfer complete.”). The custom replay module would hold off sending the “226 Transfer complete.” until it verifies that the data transfer session itself had completed (such as being notified of completion by the Standalone transfer handler).

A simple custom replay module could also handle situations of differing software between the original and recovery servers. For example, if the original server were an Apache HTTP daemon, but the recovery is handled by a Microsoft IIS server, for simple GET requests the primary problem would be in the length of the reply HTTP headers. A custom replay module would trivially look at the lengths of the original and replayed HTTP headers and adjust the offset byte count accordingly for where to start pass-through mode of the data. (Alternatively, it could send a “Range:” request and not bother wasting the server's resources uselessly repeating old data.)

Custom replay modules also make it possible to selectively abort connections that cannot be replayed. For example, a given implementation may decide that replaying an HTTP form POST command is undesirable. A custom module can easily detect POST's or URLs containing “cgi-bin”, “.cgi”, etc., and abort the connection. In accordance with another embodiment of the present invention, a more sophisticated custom replay module may be provided that understands which POST/cgi/etc. commands to allow repeats of and which to not replay; for example, a form that's an “I agree” checkbox license form at http:// . . . /license.cgi may be accepted whereas https:// . . . /charge-card.cgi that charges a credit card would probably be undesirable to repeat.

Clearly there are hazards in replaying connections. Replaying an arbitrary TELNET connection in full, for example, is certainly unwise. The user who aborted (with control-c command) an accidental “rm−r*” probably wouldn't be happy if it were replayed to continue the carnage.

There are two primary categories of issues: (1) Compatibility of new vs original server and (2) avoidance of replaying at-most-once actions. Compatibility of file systems is a major source of issues between servers, though NFS-mounted or suitably mirrored file systems ameliorate the problem. To assist with at-most-once issues, embodiments of the present invention implement multiple recovery strategies and an array of replay modules provide the functionality to easily build the desired kind of recovery on a per-protocol basis, and within a protocol, of easily writing any kind of complex decision making logic. While this does place some burden on creating custom servers or replay modules that fit a site's needs, the modules are not difficult to create, and can be written in any language that supports system calls. In addition, a library of common modules is already being built.

Embodiments of the present invention can also work synergistically with other high-availability techniques. For example, expanding on the TELNET example, if one had an xterm to a given cpu of a cluster, and that cpu crashed, one could recreate the xterm's connection on a new node with a custom replay module that doesn't execute any shell commands, but clears the screen and prints a message—instead of killing the whole session. It would be possible to not execute any of the shell commands (or other client-to-server transmissions) except those coming after the last instance of a shell prompt.

User interaction is also possible: The recovery server, e.g. a replay module, could present a list and prompt the user for which commands should be re-executed. Using this technique, even if the last command executed was a vi editor command, the editing session is replayed in full and the user is left precisely where they were before.

More complex services, such as an ODBC database connection, may be recovered in like manner, with a suitable recovery server in accordance with embodiments of the present invention. All data needed to make a determination is available to a recovery server, so coupled with journaling information, etc., TCP services can be made essentially interruption-proof.

A number of exemplary recovery servers in accordance with embodiments of the present invention for several TCP services have been tested. For simplicity we began with the finger protocol, which takes one client request and sends one server response. We successfully demonstrated that the interruption to service could occur anywhere after the connection 128 is established: before the server has begun to respond, after it is in mid-response, and after it is finished sending and about to close. (Interruption has been tested primarily in the form of doing an ifconfig “down” on the virtual interface being used; unplugging the Ethernet cable and rebooting the machine have also been used.) An Integrated style of recovery server was employed.

Recovery of HTTP sessions was tested using an Apache web server using the Proxy/replay approach. SMTP session recovery was demonstrated using sendmail and a Proxy/replay agent. FTP sessions were recovered using a wuftp-server in Proxy mode for the control connection and a Standalone recovery server for in-progress data transfers, as described above. TELNET sessions were recovered using Linux's standard TELNET daemon using a simple Proxy approach as described above. Rlogin and rcp sessions were likewise recovered. Microsoft Windows Services are in development, such that if the new Windows server has the same file system as the original server's, no difference would be noticed by the client.

In some cases it is desirable or even necessary to modify the servers, but the modifications would generally not prove extensive. For example, modifications may be desirable in connection with encrypted services, such as SSH, HTTPS, Kerberos services, etc. To recover a secure shell (SSH) session requires, for example, knowledge of the server's session keys be exported (in a secure, public-encrypted way) for use by the trusted recovery server. Recovering a database connection transaction would require, for example, participation of the original server in journaling what actions it had performed such that the recovery server could ignore already completed aspects of a transaction and resume from the appropriate point.

In accordance with a further embodiment of the present invention, additional monitors may be provided to monitor the primary monitor, and recover the monitor/recovery system itself. While this may be inefficient, it demonstrates the wide applicability of the approach.

We have considered the issues in a wide range of other protocols, and as yet not found any that pose more difficulties to handle using embodiments of the present invention than those already described above.

Until such time as TCP-based migration solutions are available on the hundreds of millions of existing systems, there will remain a need for client-transparent migration. Embodiments of the invention described herein demonstrate how certain techniques can be deployed in a simple manner, possibly even without requiring changes to an existing site architecture. Furthermore, where changes are required, they are not difficult to achieve. The simplicity and immediate applicability of the techniques disclosed herein make them attractive for adoption in commercial product development.

The difficulties involved in migrating a secure connection such as SSH primarily arise from exporting and importing various session keys securely and efficiently, and making the state of the cipher consistent. In addition, such protocols are specifically designed to prevent various attacks such as man-in-the-middle or replay attacks. Embodiments of the present invention have overcome these obstacles and devised several efficient, secure and reliable migration mechanisms.

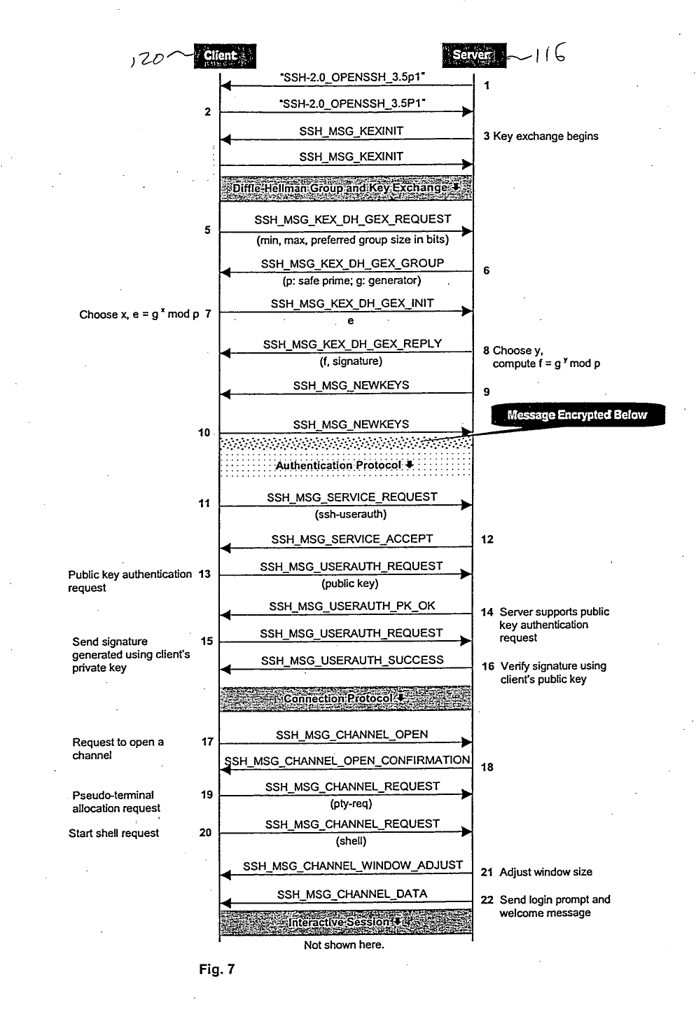

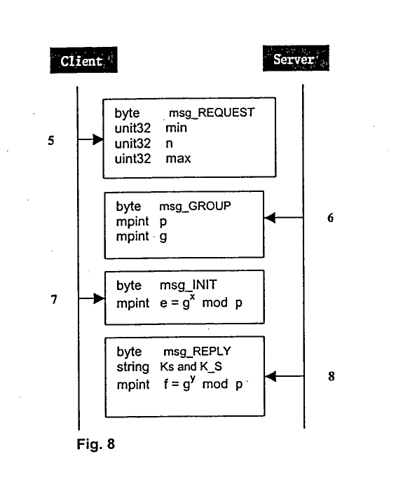

With reference now to FIGS. 6A and 6B, a recovery system 600 for use in connection with an SSH server 616 is illustrated. In particular, FIG. 6A illustrates the relationship of the recovery system 600 to the SSH server 616 and to the associated clients 120. In general, the clients 120 are no different from the clients 120 associated with embodiments of the present invention for use in connection with non-SSH servers, except that the clients 120 establish secure connections 628 with the SSH server 616.

With reference now to FIG. 6B, the recovery system 600 and its relationship to the SSH server 616 and clients 120 are illustrated following a crash of the SSH server 616. In particular, it can be seen that the secure connections 628 have been migrated to an IP address 636 and port 632 of the recovery server 608. In addition, a replay client 640, that retrieves for replay at least a portion of the initial part of the original communications between a client 120 and the original SSH server 616. The replay client 640 retrieves the communication information from the database 612.

As explained in detail elsewhere herein, embodiments of the present invention are all client-transparent protocol-level changes that are consistent with the regular operation of SSH. The main changes are to the key exchange phase on the server side: the export of several entities so that if there were to be a failure, the recovery server can recreate the original session. The exported entities include client's payload of SSH_MSG_KEXINIT message, prime p, and generator for subgroup g, server's exchange value f and its host key. The export operation is independent of the regular behavior of SSH server, in other words, it does not interfere with the normal packet exchange between client and server at all, thus it does not open new holes within the transport layer or connection protocols.

Secondly, for all the entities for export, including those mentioned above, the last block of cipher text, and message sequence number, are encrypted using the recovery server's public host key. In addition, a message digest is appended for integrity check, and the embodiment further provides non-repudiation by signing the message digest using the original server's private key. With these measures, only the recovery server can successfully decrypt these quantities with the assurance that they are from the original server and not tampered with during the export/import process.

Thirdly, access control is in place to make sure that after the original server exports those aforementioned quantities to the database, only the recovery server 608 is allowed to access them. This is possible because to the original SSH server, the recovery server is a known identifiable entity, i.e., the database can authenticate the recovery server before granting access.

Finally, all these extra exporting and importing happen in a dedicated point-to-point physical channel and is totally transparent to the client or the third party. From the third party's point of view, the CPR is just like a regular SSH session, except that it is short and the recovery server promptly resumes connection to the original client at the end of it.

As can be appreciated from the description herein, embodiments of the present invention provide tools that enhance reliability, which can easily be attached to the existing infrastructure without making any modifications to the client. This contrasts with previous solutions whose purpose is to provide continuity of service for mobile clients, perform dynamic load balancing using content-aware request distribution, do socket migration as part of a more general process migration, or build network services that scale. The difference in motivation between embodiments of the present invention and the previous methods presents special challenges and has subtle effects on architecture.

One way to achieve fault tolerance is to build recovery machinery into the server and develop clients to take advantage of this feature. The feature may be user controlled, such as the “REST” restart command in FTP, or it may be hidden from user control. An example of such a methodology is Netscape's SmartDownload that is currently gaining some popularity. This approach requires modifying the clients and servers, and recoding of applications.

SSH is a protocol for secure remote login and other secure network services over an insecure network. SSH encrypts all traffic to effectively eliminate eavesdropping, connection hijacking, and other network-level attacks. Additionally, it provides myriad secure tunneling capabilities and authentication methods. With an installed base of several million systems, it is the de-facto standard for remote logins and a common conduit for other applications. Increasingly, many organizations are making SSH the only allowed form of general access to their network from the public Internet (i.e., other than more specialized access such as via HTTP/HTTPS).

SSH consists of three major components: The Transport Layer Protocol provides server authentication, confidentiality, and integrity with perfect forward secrecy. The User Authentication Protocol authenticates the client to the server. The Connection Protocol multiplexes the encrypted tunnel into several logical channels.

With reference now to FIG. 7, protocol level packet exchange during a typical SSH session is illustrated. When the connection has been established, both sides send an identification string in steps 1 and 2. After exchanging the key exchange message (SSH_MSG_KEXINT). in steps 3 and 4, each side agrees on which encryption, Message Authentication Code (MAC) and compression algorithms to use. Steps 5 through 8 consist of Diffie-Hellman group and key exchange protocol which establishes various keys for use throughout the session. Following the successful key setup phase, signaled by the exchange of new keys message (SSH_MSG_NEWKEYS) in steps 9 and 10, messages are encrypted throughout the rest of the session.

Steps 11 to 16 illustrate user authentication protocol, in particular, the public key authentication method. Steps 17 and above illustrate the SSH connection protocol, which provides interactive login sessions, remote execution of commands, and forwarded TCP/IP connections. FIG. 7 also illustrates opening a remote channel (17, 18), and pseudo-terminal and shell start requests (19, 20). After the server sends the login prompt and greeting messages, the client begins transferring data, entering interactive session.

Embodiments of the present invention include a full replay “Proxy” based approach and Controlled Partial Replay approach (CPR). As described elsewhere herein, Proxy style recovery daemon is a standalone piece of software with some understanding of the protocol whose sessions are to be recovered. However, it does not listen on any original service port, only on a port dedicated to recovery requests. When a recovery request arrives, the Proxy opens a new connection to an existing service daemon on a designated recovery host and replays most of the entire initial part of the original conversation between the client and original server, a conversation it retrieves from the monitor's database. After replaying the connection up to the point it was (almost) disrupted, the Proxy simply acts as a two-way pipe between client and new server. In recovering an SSH daemon, the Proxy recovery daemon would invoke a new sshd (SSH daemon) process then replay the entire original conversation to the recovery SSH daemon (acting as if it were the client), so that the new sshd could advance the state of the encryption engine to match that of the original and now defunct sshd. (The new sshd would have itself been modified to use the same encryption data as the original, as is discussed below, in that this is a modification necessary to both approaches.)

In the CPR approach, once the monitor detects server failure, the CPR daemon starts an SSH recovery server, which is a modified copy of the regular SSH server. The CPR daemon then performs a brief replay of the client process that mimics the original SSH client in that it sends and receives the same sequences of the same packets in the same order as the original client. (These are in no way sent to or seen by the original client.) The recovery server is modified to generate the same set of encryption/decryption/MAC keys as the original session, as described below. This replay proceeds until authentication and connection are successful and the recovery server arrives at the same connection state as the original server was. The recovery client then ends the partial replay process by sending to the recovery server a user-defined message “SSH_USEFUL_REPLAY_END” which contains TCP/IP kernel parameters (sequence numbers, port numbers, IP addresses, etc.). Upon receiving this message, the recovery server restores these TCP/IP kernel parameters via a small kernel module loaded on the recovery system, so that the sshd process invisibly resumes the connection to the original client, thus completing the recovery process. The recovery client terminates itself afterwards.

In order for CPR to work, confirmation is needed that the SSH recovery server as well as the recovery client can derive the same set of keys as those of the original session, and in a secure manner. In addition, protocol specifics are addressed which normally are designed to prevent replay from happening in the first place.

Lastly, while the modifications needed for recovery must be made to the SSH software on the server side, the changes are not complex (in that they address the protocol and not the specific implementation), and can be easily expressed as simple patches for existing versions of SSH; ultimately these may be incorporated directly into future SSH revisions as standard functionality or optional modules.

The first step for the recovery server and recovery client to reproduce the keys is to force the recovery server to send the same SSH_MSG_KEXINIT in step 3 in FIG. 7. This is because SSH_MSG_KEXINIT contains 16-bytes of random data generated by the sender and used as an input to future key and session identifier generating functions.

Therefore, confirmation is needed that the recovery server generates the same SSH_MSG_KEXINIT as that of the original server, so that both the recovery client and server can derive the same set of keys as those of the original session. This is accomplished, in one embodiment, in a straightforward manner: modify the original server so that it exports the 16-byte random number, after encrypting it using the recovery server's public key (and signing with the original server's private key); this is exported through secure channel to the recovery server for later use, should recovery be called for. During the CPR process, instead of generating the random numbers on the fly as is the normal mode of operation for SSH, the recovery server imports the saved value, decrypts it using its private key (validates the signature), and finally produces the same SSH_MSG_KEXINIT.

As discussed earlier, the Diffie-Hellman group and key exchange is a secure key exchange method that produces a unique set of keys. The current SSH Transport Layer Protocol only designates Diffie-Hellman key exchange as the required method. However, the Diffie-Hellman group and key exchange method offers better security because it uses a different group for each session, and is the default key exchange method deployed in OpenSSH. Therefore, without loss of generality, it is assumed herein.

In FIG. 8, step 5-8 of FIG. 7 are expanded to illustrate this key exchange method of this embodiment in detail. Note that 11 denotes string concatenation.

In step 5 of FIG. 8, the client sends min, n, and max to the server, indicating the minimal acceptable group size, the preferred size of the group and the maximal group size in bits the client will accept. In step 6, the server finds a group that best matches the client's request, and sends p and g to the client. In step 7, client generates a random number x. It computes e=g^{x} mod p, and sends “e” to server. In step 8, server generates a random number y and computes f=g^{y} mod p. When the server receives “e” it computes K=e^{y} mod p, and H=hash(V_{c}∥Vₛ∥I_{c}∥Iₛ∥Kₛ∥ min ∥n∥max∥p∥g∥e∥f∥K) where
V_{c}&Vₛ—client's & server's version strings, respectively
Kₛ—server host key
p—safe prime
I_{c}&Iₛ—the payload of the client & server's SSH_MSG_KEXINIT, respectively
min & max—minimal & maximal size in bits of an acceptable group, resp
n—preferred size in bits of the group the server should send
K—the shared secret
g—generator for subgroup
f—exchange value sent by the server
K_S—server certificate

Various encryption keys are computed as hash of a K and H and a known single character.

Following the above description, the entities that are unique to each session that affect key generation are: V_{c}, Vₛ, I_{c}, Iₛ, Kₛ, min, n, max, p, g, e, f, K and H. In this embodiment, the recovery client replays the messages previously sent by the original client, thus V_{c}, I_{c}, min, n, max, e will be the same for the recovery session, but other items that are normally generated at run time by the server must be the restored as those originally used. Because the recovery server is only a slightly modified version of the original server, it will thus produce the same Vₛ. Therefore, the entities that are needed to force the recovery server to duplicate in order to generate the same set of keys are: Iₛ, p, g, f, and Kₛ. The original SSH server is modified so that it encrypts these aforementioned entities using recovery server's public key, appends with message digest, signs and exports them to a secure network location. For the recovery server, instead of generating these host-specific entities dynamically, it reads them in from the secure location, decrypts them using its private host key, verifies message digest and signature, and generates the same packets to be sent to client in step 6 and 8 in FIG. 8. In doing so, the recovery server and the corresponding recovery client will produce the same set of initial IVs, as well as encryption and integrity keys, enabling our CPR to proceed.

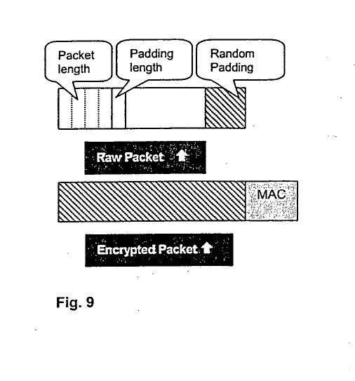

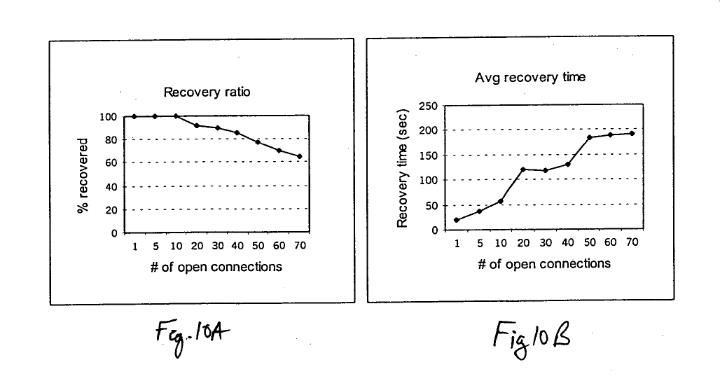

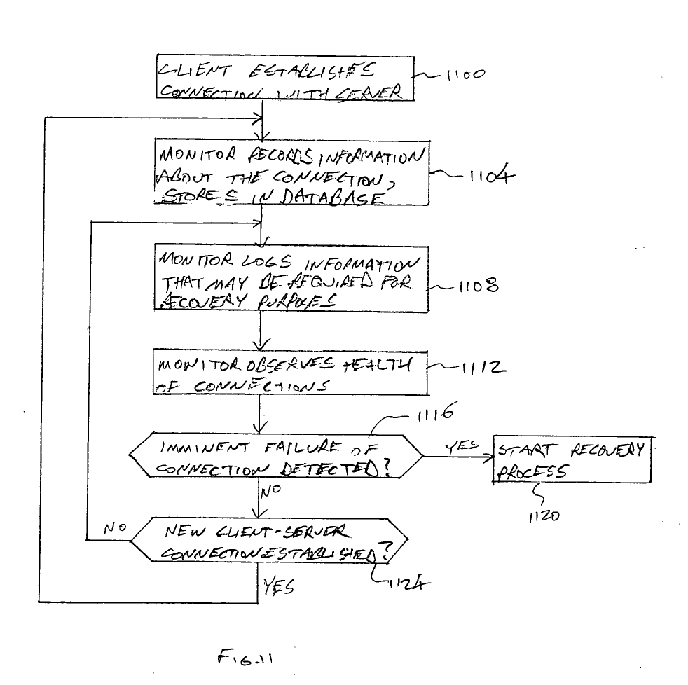

According to the SSH Transport Layer Protocol, each SSH packet includes, respectively, 4 bytes in a packet length field, 1 byte in a padding length field, a payload field, and random padding. The encrypted packets have an additional MAC field at the end as described below. Packet format before and after encryption is depicted in FIG. 9.

According to the export/import method described earlier, the same encryption algorithms and identical set of keys will be used during CPR. However, for block ciphers, the previous block of cipher text, denote as Cᵢ, is used as the random data that will be XOR'd into the next plaintext. This in essence, means that, though starting with the same sets of keys, because of only doing a partial replay, an inconsistent cipher context may occur at the end of CPR. Two embodiments solve this problem: (1) to modify the original SSH server to export the most recent Cᵢ with every packet encryption and decryption, and to reset the cipher context of the SSH recovery server to Cᵢ at the end of CPR; vs. (2) to modify the regular SSH server to securely export every raw packet, so that the cipher context can be advanced by applying encryption/decryption over all the saved raw packets. Both of these two approaches have been implemented, and found that the first approach is just as effective without the inefficiency of saving all the raw packets.

As illustrated in the embodiment of FIG. 9, each encrypted packet is appended with a Message Authentication Code (MAC) to achieve data integrity. MAC is produced according to the following formula:
MAC=mac_algorithm(key, sequence_number∥
unencrypted_packet)
where unencrypted_packet is the entire packet without MAC and sequence_number is an implicit 32 bit packet sequence number. The sequence number is initialized to zero for the first packet, and is incremented after every packet.

Of the three parameters to MAC, the only entity that is unique to every packet in each session is the sequence_number. The regular SSH server is thus modified to securely export the latest sequence number after each packet send/receive operation. At the end of CPR, the sequence_number of the recovery server is set as the latest one from the original session.

Random Padding

The random padding field consists of randomly generated bytes to ensure the total length of the raw packet is a multiple of the cipher block. Although the recovery server and original server generate different random padding for their packets, it is not necessary to alter the recovery server in order to reconcile this inconsistency. This is because both the recovery client and recovery server will derive the same encryption and MAC algorithms after the key exchange phase, as well as the same set of keys, which enables the recovery client to successfully decrypt any packet received from the recovery server and to proceed until CPR ends. The only ramification of different random padding is that the recovery server's cipher context, or the last block of cipher text (Cᵢ), will be different from that of the original server. However, as explained in section 5.1, the cipher context of the recovery server is reset at the end of CPR to make it consistent with the original server, thus making exporting and importing random padding field unnecessary.

Application state is recovered in a manner generally addressed in the art. For a given application (such as a remote shell or a specific application invoked using SSH) a per-application recovery module is created. These are generally simple to create, and may be crafted from existing models. The primary issue in an application recovery module is for it to monitor the original connection and extract relevant state from it. This can be restored by replay to an unmodified application daemon or by directly setting state into a daemon modified for that purpose. For example, highly non-deterministic applications like a shell session can display a list of previously executed commands for the user to choose to re-execute. More deterministic applications, such as FTP, can have their state replayed by a simple proxy client directly.

The primary difference between recovery applications under embodiments of the present invention for use in connection with SSH and other embodiments of the present invention is that the recovery module of SSH recovery embodiments must be connected into the SSH monitor, so it can decrypt the session's application communications to determine which are relevant state-setting messages, e.g., a CHDIR command in FTP, or gathering the list of commands executed for a login session. However, since the SSH software has been slightly modified for recovery purposes anyway, this is not a significant imposition.

OpenSSH 3.5 is used in an embodiment and modified the source code to create both the regular and recovery SSH server. Experiments were conducted on several very modest machines (each an Intel Pentium 333 MHz with 128M memory and Intel Ethernet Pro 10/100B PCs running Red Hat 7.2 with a mySQL database).

The fundamental measure of success in this case is whether SSH connections can be restored before TCP's abort timer expires and the clients begin resetting connections. This value is established on the order of multiple minutes, with two minutes being the general minimum and nine minutes the common value. Recovery even under load takes less than two minutes in an embodiment.

The following shows the time spent in a representative SSH recovery session:

| | |
|---|---|
| Monitor alerts of server crash: | 17:39:21 |
| Recovery start: | 17:39:26 |
| IP take over and recovery server | 17:39:32 |
| daemon started: | |
| Recovery complete: | 17:39:40 |

It takes approximately 11 seconds to discover a server crash, reset the virtual interface, and start a recovery daemon. The actual recovery process, which includes controlled partial replay, reading and decrypting the saved parameters, and resetting the recovery server's encryption cipher states, takes another 8 seconds. This is compared to observations that show a regular client login to server takes, on average, 3.2 seconds.

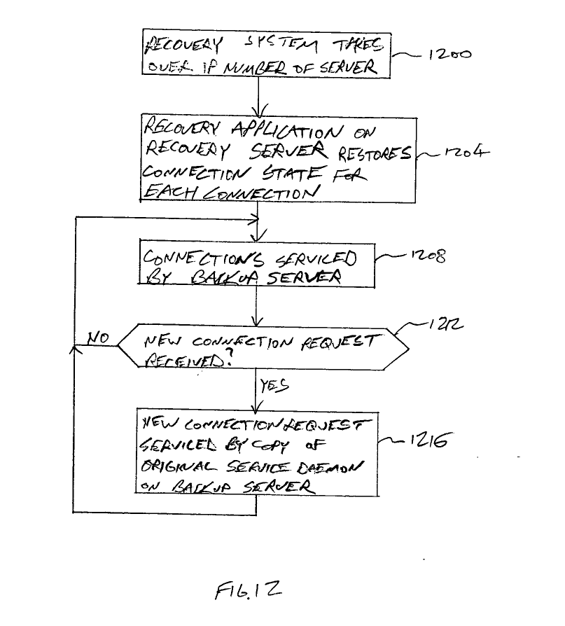

With reference now to FIG. 11, aspects of the operation of a monitor 104 provided as part of a recovery system 100 in accordance with embodiments of the present invention are illustrated. Initially, a client 120 establishes a connection 128 with a server 116 (step 1100). The monitor 104 of the recovery system 100 records information about the connection 128, and stores that information in the recovery system database 112 (step 1104).

As the connection 128 continues, the monitor 104 logs information that may be required for recovery purposes in the recovery system database 112. Such information may include logging packets at the TCP level by a sniffer. Logged packets may include acknowledged packets, in case a recovery daemon later desires to inspect earlier communications. Packets that have been acknowledged may later be removed if they are determined to be unnecessary to any later recovery operations that may occur.

The monitor 104 also observes the health of the connections 128 (step 1112). Monitoring may include determining whether a given service has become unavailable. For instance, the monitor can periodically ping the virtual IP number associated with the server to determine network reachability, TCP retransmit requests, attempting to connect to a stalling service, and interaction with a health daemon running on the server 116. A determination is then made as to whether imminent failure of a connection 128 has been detected by the monitor (step 1116). Imminent failure may be indicated by, for example, failing to receive a reply to pinging of the virtual IP number of the server 1116, an abnormal volume of retransmit requests, or information received from a health daemon running on the server 1116 indicating that a given service is no longer alert or functioning properly. If imminent failure of a connection 128 is detected, a recovery process is started (step 1120), as will be described in greater detail elsewhere herein. If imminent failure of the connection is not detected, a determination may be made as to whether a new client server connection 128 has been established (step 1124). If a new connection 128 is established, the process returns to step 1104. If a new connection is not established, the process returns to step 1108. Accordingly, the process may continue running until the recovery system 100 is disconnected or shut down.

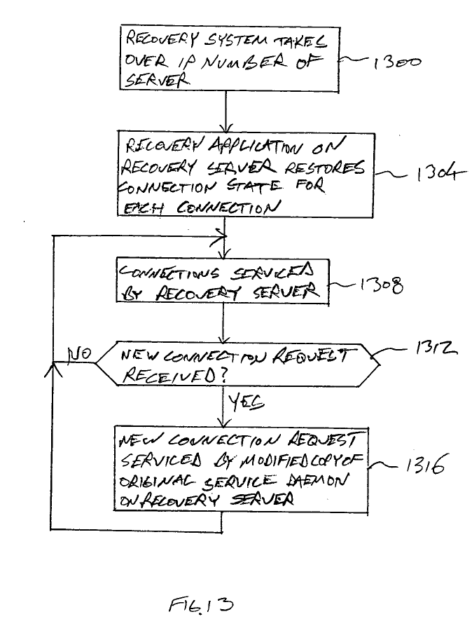

With reference now to FIG. 12, aspects of the operation of a standalone recovery system 100 in accordance with embodiments of the present invention are illustrated. In general, the recovery process described in connection with FIG. 12 may take place after imminent failure of a connection is detected by a monitor 104. Initially, the recovery system 100 takes over the IP number of the server 116 (step 1200). A recovery application on the recovery server 108 restores the connection state for each connection 128 (step 1204). The connections 128 are then serviced by a backup server 124 that is provided separately from the recovery system (step 1208).

At step 1212, a determination is made as to whether a new connection request has been received. If a new connection request is received, the new connection request is serviced by a copy of the original service daemon running on the backup server 124 (step 1216). After servicing the new connection request, or if no new connection request is received, the process returns to step 1208.

Accordingly, it can be appreciated that a standalone type recovery system 100 does not itself include a backup server 124 capable of servicing clients after connections have been migrated from the original server 116. In addition, new connection requests are serviced by the backup server 124 directly.

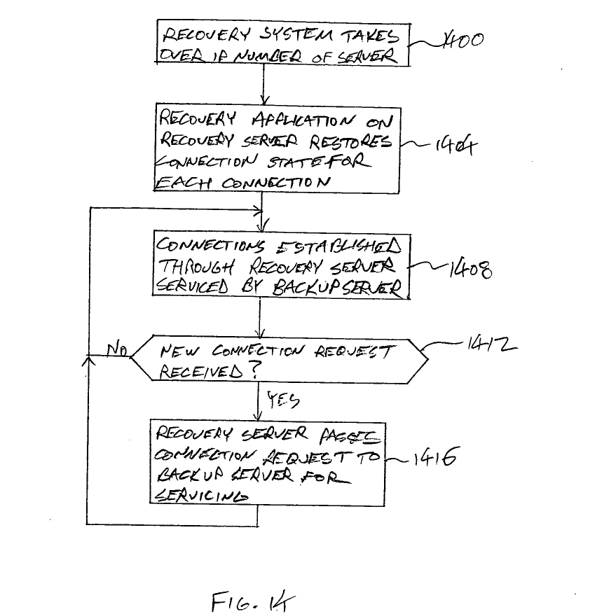

With reference now to FIG. 13, aspects of the operation of an integrated type recovery system 100 in accordance with embodiments of the present invention are illustrated. As with the standalone type recovery system, the operation of the integrated type recovery system 100 shown in FIG. 13 may commence upon a determination by the monitor 104 that failure of a connection 128 is imminent. Initially, at step 1300, the recovery system 100 takes over the IP number of the server 116. A recovery application running on the recovery server 108 restores the connection state for each connection (step 1304). The connections 128 are then serviced by the recovery server 108 (step 1308).

At step 1312, a determination is made as to whether a new connection request has been received. If a new connection request is received, that new connection request is serviced by a modified copy of the original service daemon running on the recovery server 108 (step 1316). If a new connection request is not received, or after servicing the new connection request by a copy of the original service daemon running on the recovery server 108, the process may return to step 1308.

Accordingly, it can be appreciated that an integrated type recovery system 100 incorporate a backup server.

With reference now to FIG. 14, aspects of the operation of a proxy type recovery system 100 in accordance with embodiments of the present invention are illustrated. As with the standalone and integrated type recovery systems 100, the proxy type recovery system 100 generally begins recovery operations after a determination by the monitor 104 that failure of a connection 128 is imminent. Initially, at step 1400, the recovery system 100 takes over the IP number of the server 116. A recovery application running on the recovery server 108 then restores the connection states for each connection 128 (step 1404). Connections established through the recovery server 108 are actually routed to and serviced by a separate backup server 124 (step 1408).

At step 1412, a determination is made as to whether a new connection request is received. If a new connection request is received, the recovery server 108 passes the connection request to the backup server 124 for servicing (step 1416). After passing the connection request to the backup server 124, or if no new connection request is received, the process may return to step 1408.

Accordingly, it can be appreciated that a proxy type recovery system 100 takes over the IP address 136 of the server 116, and continues to use that IP address 136 to pass both existing connections 128 and request for new connections to a separate backup server 124.

Until such time as secure TCP-based migration solutions are available on the hundreds of millions of existing systems, there will remain a need for client-transparent migration. The SecureJeebs system as described in the above embodiments enables certain techniques to be deployed in a simple manner, without requiring changes to any clients. The simplicity and immediate applicability of the techniques demonstrated herein make SecureJeebs attractive for adoption in commercial product development.

Some embodiments of the disclosed invention provide techniques to make TCP-based Internet services involving long-running connections impervious to server crashes. Using these techniques, simple, practical systems can be built that can be retrofitted into the existing infrastructure, e.g., no changes need to be made either to the TCP/IP protocol, to the client, or (except in rare circumstances) to the server daemon. The end result is a practical, drop-in method of adding significant robustness to almost all existing network services. In particular, embodiments of the disclosed invention can provide enhanced reliability, without having to upgrade software already installed on clients.

According to embodiments of the present invention, the end result is a drop-in method of adding significant robustness to secure network connections such as those using the secure shell protocol (SSH). As there is a large installed universe of TCP-based user agent software, it will be some time before widespread adoption takes place of other approaches designed to withstand these kind of service failures; methods of the embodiments of the disclosed invention provide an immediate way to enhance reliability, and thus resistance to attack, without having to wait for clients to upgrade software at their end.

As can be appreciated by one of skill in the art from the description provided herein, embodiments of the present invention are not limited to use in association with IP connections. For example, embodiments of the present inventions provide a method for migrating the locus of computing of an application, network protocol, or secure protocol from one location to another by duplicating the application state, network protocol state, or secure protocol state. Migration may include initiating or establishing computing of an application, network protocol, or secure protocol at a first computing location, and duplicating an application state, network protocol state, or secure protocol state. In order to migrate computing to a second computing location, the duplicated application state, network protocol state or secure protocol state is played back to the second computing location, allowing computing of the application, network protocol or secure protocol to be established at the second computing location.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to include the alternative embodiments to the extent permitted by the prior art.

1. A method for migrating a communication channel, comprising;
monitoring a connection over a communication channel established between a first client and a first server;
in response to an imminent failure, establishing an alternate connection with a second server; and
migrating said communication channel from said first server to said second server, wherein said monitoring and migrating are performed by a component that is separate from said first client and said first server, and wherein implementation of said monitoring and said migrating does not require modifications to said first client.

2. The method of claim 1, wherein implementation of said monitoring and said migrating does not require modifications to said first server.

3. The method of claim 1, wherein said monitoring a communication channel comprises monitoring at least some ports associated with an IP address.

4. The method of claim 1, wherein said monitoring a communication channel comprises logging traffic from said first server.

5. The method of claim 4, wherein said logging comprises recording TCP state information, unacknowledged data, and prior data required for recovery purposes.

6. The method of claim 1, wherein said monitoring comprises observing a status of said connection to detect an imminent failure.

7. The method of claim 1, wherein said monitoring comprises pinging.

8. The method of claim 1, wherein said monitoring comprises detecting a retransmit request.

9. The method of claim 1, wherein said monitoring comprises attempting to connect to a service.

10. The method of claim 1, wherein said establishing an alternate connection comprises establishing a connection between said first client and said second server through a proxy server.

11. The method of claim 1, wherein migrating a communication channel from said first server to said second server comprises:
retrieving a TCP connection state for said connection;
opening a new socket;
placing TCP state information onto the new socket; and
recovering a service.

12. A device for providing an alternate communication channel, comprising:
a monitor, wherein a record of information regarding an existing communication channel between a client and a primary server is maintained; and
a recovery system, wherein in response to a signal from said monitor, a connection comprising said existing communication channel is migrated to an alternate server.

13. The device of claim 12, further comprising an alternate server wherein said recovery system comprises a recovery daemon that is integrated with said alternate server.

14. The device of claim 12, further comprising an application server, wherein said application server provides services in addition to services provided by said primary server, and wherein said recovery system comprises a recovery daemon that is integrated with said application server.

15. The device of claim 12, wherein said primary server comprises an application server.

16. The device of claim 17, wherein said recovery system comprises a recovery daemon running on a server that is separate from an application server.

17. A computational component for performing a method, the method comprising:
monitoring at least a first connection between a client and port of a server associated with a first IP address;
determining whether a failure of said at least a first connection is imminent; and
in response to determining that a failure of said at least a first connection is imminent, migrating said at least a first connection to a port of a device other than said server, wherein said device other than said server uses said first IP address.

18. The method of claim 17, wherein said monitoring includes logging data associated with said at least a first connection in a database.

19. The method of claim 17, wherein a plurality of connections are established between a plurality of clients and ports of said server associated with a first IP address, and wherein in response to determining that a failure of said at least a first connection is imminent at least a number of said connections are migrated to said device other than said server.

20. The method of claim 17, wherein said device other than said server comprises a backup server.

21. The method of claim 20, wherein said backup server is integrated with said monitor and said recovery server.

22. The method of claim 17, wherein said device other than said server comprises said recovery server, and wherein said recovery server acts as a proxy for a backup server with respect to said connection.

23. The method of claim 17, wherein said migrating comprises replaying at least a portion of data comprising previous traffic over said first connection.

24. The method of claim 17, wherein said at least a first connection comprises a TCP connection.

25. A connection recovery system, comprising:
means for servicing a connection, said means for servicing associated with at least a first IP address;
means for providing a backup to said means for servicing a connection;
means for monitoring a status of at least a first existing connection with said first IP address;
means for storing data obtained from said monitoring; and
recovery server means for migrating said at least a first existing connection from a failing service to said means for providing a backup to said means for servicing a connection, wherein in response to said means for monitoring determining that a failure of said at least a first connection is imminent, said recovery server means takes over said at least a first IP address to enable said at least a first connection to be migrated to said means for providing a backup to said means for servicing a connection.

26. The system of claim 25, further comprising:
means for replaying information associated with said at least a first connection before migration, wherein said information is replayed to said means for providing a backup to said means for establishing a connection.

27. A method for migrating a locus of computing, comprising:
establishing computing of at least one of an application, a network protocol and a secure protocol at a first computing location;
duplicating at least one of an application state, network protocol state and secure protocol state;
playing back said duplicated at least one of an application state, network protocol state and secure protocol state to a second computing location; and
establishing computing of said at least one of an application, a network protocol and secure protocol at said second computing location.
